(19) United States
(12) Patent Application Publication
(10) Pub. No.: US 2004/0168515 A1
(43) Pub. Date: Sep. 2, 2004

(54) Multiple-threshold multidirectional inertial device

(75) Inventors: Ernesto Lasalandra, S. Donato Milanese (IT); Fabio Pasolini, S. Martino Siccomario (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 10/788,962

(22) Filed: Feb. 27, 2004

(30) Foreign Application Priority Data
Feb. 28, 2003 (IT) TO2003A 000142

(51) Int. Cl. G01P 15/18; G01P 15/125

(52) U.S. Cl. 73/510; 73/514.32

(57) ABSTRACT

A multidirectional inertial device having a plurality of preferential detection axes includes: inertial sensors, sensitive to accelerations in a direction parallel to the preferential detection axes; transduction stages, which are coupled to the inertial sensors and supply a plurality of acceleration signals, each of which is correlated to an acceleration parallel to a respective preferential detection axis; a first comparison circuit, which is connected to the transduction stages and supplies a pre-set logic value when at least one of the acceleration signals is greater than a respective upper threshold; and a second comparison circuit, connected to the transduction stages and to the first comparison circuit for supplying the pre-set logic value when each of the acceleration signals is greater than a respective lower threshold, which is smaller than the respective upper threshold.

### BACKGROUND OF THE INVENTION

1. Field of the Invention

The present invention relates to a multiple-threshold multidirectional inertial device.

2. Description of the Related Art

Multidirectional inertial devices (inertial switches) are known, which detect the accelerations due to forces acting in at least two independent directions and supply a recognition signal when the components of a force according to one of these independent directions exceeds a pre-determined threshold. In particular, inertial devices based upon MEMS (Micro-Electro-Mechanical System) inertial sensors are currently available; advantageously, MEMS inertial sensors have high sensitivity, contained overall dimensions and, above all, virtually negligible consumption.

As is known, a MEMS inertial sensor comprises a fixed body and a moving element, connected to one another by elastic suspension elements, which enable a relative movement of the moving element with respect to the fixed body according to pre-determined degrees of freedom, either rotational or translational. Consequently, a force acting on the inertial sensor (or, equivalently, the acceleration due to the application of said force) causes a displacement of the moving element with respect to the fixed body in accordance with the degrees of freedom allowed by the elastic suspension elements. Furthermore, respective preferential detection axes of the inertial sensor correspond to such degrees of freedom: in practice, the displacement of the moving element with respect to the fixed body is maximum when the direction of a force (or of a moment, in the case of rotational sensors) acting on the sensor is parallel to a preferential detection axis.

Normally, a multidirectional inertial device comprises a MEMS inertial sensor having at least two degrees of translational freedom (and thus two preferential detection axes), or else at least two sensors having a translational degree of freedom and respective preferential detection axes that do not coincide and are preferably orthogonal to one another. As mentioned previously, a recognition pulse is generated whenever the component of an acceleration along one of the preferential detection axes exceeds a pre-set threshold. Furthermore, the threshold is preferably the same for all the axes.

Known inertial devices suffer, however, from some limitations. It is in fact evident that a force or, equivalently, the acceleration caused by this force, albeit having an intensity higher than the pre-determined threshold, may fail to be detected if its direction shifts away significantly from the preferential detection axes. In this case, the components of this acceleration along the preferential detection axes may be less than the pre-set threshold.

For reasons of greater clarity, reference is made to FIG. 1, which shows a first preferential detection axis X and a second preferential detection axis Y of a bi-directional inertial device, herein not illustrated, comprising for example two linear MEMS inertial sensors (i.e., having one translational degree of freedom); for both of the preferential detection axes a same threshold S is fixed. FIG. 1 moreover shows an acceleration, which has a magnitude A greater than the threshold S and forms an angle a with the first preferential detection axis X. The components of the acceleration along the preferential detection axes, herein designated by Aₓ, A_{y}, are equal to:

A_{X}=A cos α

A_{Y}=A cos(90°−α)

In the worst case, to which FIG. 1 refers, the angle α is 45°, so that we have:

A_{X}=A_{Y}=A/\sqrt{2}

It is thus evident that the acceleration is not detected if:

A<S/\sqrt{2}=S·1.41

In other words, the detection of a direct acceleration can fail even if the magnitude of the acceleration is considerably greater than the threshold S.

On the other hand, in a large number of cases the mere lowering of the threshold S is not satisfactory, since even disturbance of modest intensity would be detected, too. Furthermore, reconstruction of the exact value of the acceleration by analogical processing of the signals provided by the inertial sensors would not be acceptable, because it would entail so high a power consumption as to nullify the saving achieved due to the use of MEMS inertial sensors.

### BRIEF SUMMARY OF THE INVENTION

An embodiment of the present invention overcomes the limitations described by improving the detection of the forces and/or of the accelerations to which the inertial device is subjected.

According to the present invention a multiple-threshold multidirectional inertial device is provided.

### BRIEF DESCRIPTION OF THE DRAWINGS

For a better understanding of the invention, an embodiment thereof is now described, purely by way of non-limiting example and with reference to the attached drawings, in which:

FIG. 1 illustrates graphs corresponding to quantities present in a known inertial device;

FIG. 2 is a schematic top plan view of a known inertial sensor; and

FIG. 3 illustrates a simplified block diagram corresponding to an inertial device according to the present invention;

FIG. 4 illustrates graphs corresponding to quantities present in the inertial device of FIG. 3; and

FIG. 5 shows a partially sectioned top plan view of a portable electronic apparatus incorporating the inertial device of FIG. 3.

### DETAILED DESCRIPTION OF THE INVENTION

FIG. 2 illustrates, for reasons of clarity, an inertial sensor 1, of a known type, having a preferential detection axis A. In detail, the inertial sensor 1 comprises a stator 2 and a moving element 3, connected to one another by means of springs 4 in such a way that the moving element 3 is able to translate parallel to the first preferential detection axis A.

The stator 2 and the moving element 3 are provided with a plurality of first and second stator electrodes 5′, 5″ and, respectively, with a plurality of mobile electrodes 6. Each mobile electrode 6 is positioned between two respective stator electrodes 5′, 5″, which it partially faces; consequently, each mobile electrode 6 forms, with the two adjacent fixed electrodes 5′, 5″, first and, second capacitors, with plane and parallel faces, respectively. Furthermore, all the first stator electrodes 5′ are connected to a first stator terminal 1a, and all the second stator electrodes 5″ are connected to a second stator terminal 1b, while the mobile electrodes 6 are grounded. Consequently, from the electrical point of view, the inertial sensor 1 can be idealized as a first equivalent capacitor 8 and a second equivalent capacitor 9 (illustrated herein with dashed lines), having first terminals connected to the first stator terminal 1a and, respectively, to the second stator terminal 1b, and second terminals connected to ground. Furthermore, the first equivalent capacitor 8 and the second equivalent capacitor 9 have variable capacitances correlated to the relative position of the moving element 3 with respect to the rotor 2; in particular, the capacitances of the equivalent capacitors 8, 9 at rest are equal and are unbalanced in the presence of an acceleration oriented according to the preferential detection axis (in this case, the first axis X).

According to what is illustrated in FIG. 3, a multidirectional inertial device according to an embodiment of the present invention, designated as a whole by the reference number 10, comprises a first inertial sensor 11 and a second inertial sensor 12, coupled to a first transduction stage 14 and, respectively, to a second transduction stage 15, and a comparison stage 16.

The inertial sensors 11, 12 are linear sensors with capacitive unbalancing, which are made using MEMS technology and are of the type described previously with reference to FIG. 1. In particular, the first inertial sensor 11 and the second inertial sensor 12 have a first preferential detection axis X and, respectively, a second preferential detection axis Y, which are perpendicular to one another and form preferential detection axes of the inertial device 10.

Each of the transduction stages 14, 15 comprises a current to voltage (C-V) converter 17, a filter 18, a subtractor node 19, and a rectifier 20.

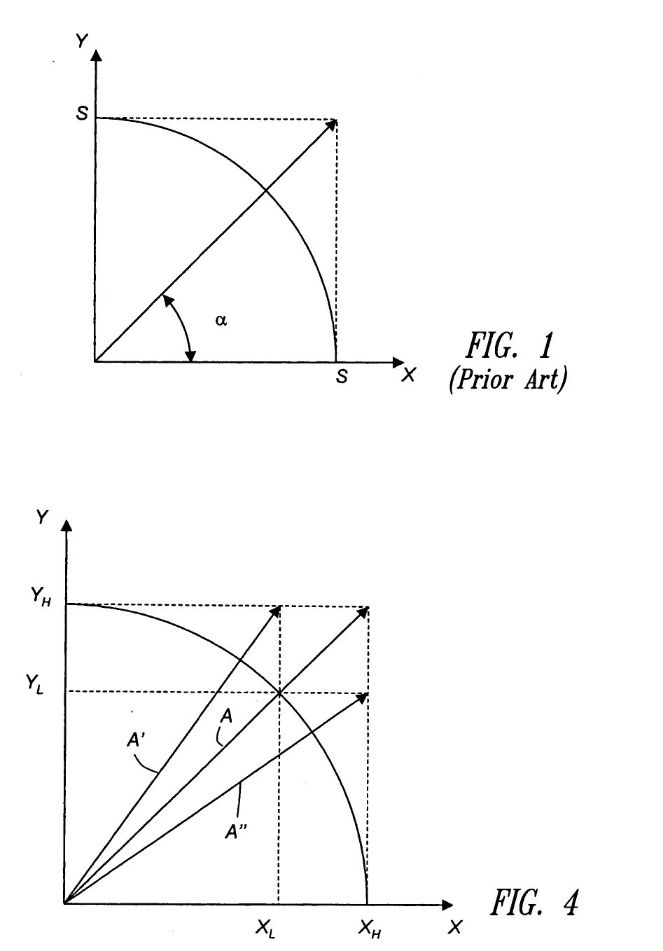

In greater detail, the C-V converter 17 of the first transduction stage 14, which is in itself known, is based upon a differential charge-integrator circuit and has inputs connected to the first stator terminal 11a and to the second stator terminal 11b of the first inertial sensor 11. In practice, the C-V converter 17 of the first transduction stage 14 reads the capacitive unbalancing ΔCₓ of the first inertial sensor 11 and supplies at one of its outputs 17a a first acceleration signal Aₓ, correlated to the component of an acceleration A, which is directed along the first preferential detection axis X and is due to forces acting on the first inertial sensor 11 (see also FIG. 4). The output 17a of the C-V converter 17 is moreover connected to a non-inverting input of the subtractor node 19.

The filter 18, which is of a low-pass type, is connected between the output 17a of the C-V converter 17 and an inverting input 19a of the subtractor node 19. In practice, the filter 18 extracts the continuous component of the first acceleration signal Aₓ and supplies at its output a first static-acceleration signal Aₓₛ, exclusively correlated to the accelerations which are oriented according to the first preferential reference axis X, and are due to constant forces, such as the force of gravity.

The subtractor node 19 has an output, which is connected to the rectifier 20 and supplies a first dynamic-acceleration signal A_{XD}, exclusively correlated to the accelerations which are oriented along the first preferential reference axis X and are due to variable forces. In practice, the subtractor node 19 determines the first dynamic-acceleration signal A_{XD}, by subtracting the first static-acceleration signal A_{XS} from the first acceleration signal A_{X}.

The rectifier 20 is connected between the output of the adder node 19 and the comparison stage 16; moreover, an output of the rectifier 20 forms an output 14a of the first transduction stage 14 and supplies the absolute value |A_{XD}| of the first dynamic-acceleration signal A_{XD}.

In the second transduction stage 15, the C-V converter 17, the filter 18, the subtractor node 19, and the rectifier 20 are connected to one another, as described above concerning the first transduction stage 14.

Furthermore, the C-V converter 17 of the second transduction stage 15 has inputs connected to the first stator terminal 12a and to the second stator terminal 12b of the second inertial sensor 12. In practice, the C-V converter 17 of the second transduction stage 15 reads the capacitive unbalancing ΔC_{Y} of the second inertial sensor 12 and supplies on its output 17a a second acceleration signal A_{Y}, correlated to the component of an acceleration A, which is parallel to the second preferential detection axis Y and is due to the forces acting on the first inertial sensor 11 (FIG. 4). Furthermore, the filter 18 and the subtractor node 19 supply a second static-acceleration signal A_{YS} and, respectively, a second dynamic-acceleration signal A_{YD}, correlated to the accelerations which are oriented parallel to the second preferential detection axis Y and are due to the constant forces and variable forces, respectively, acting on the second inertial sensor 12. The rectifier 20, the output of which forms an output 20b of the second transduction stage 15, supplies the absolute value |A_{YD}| of the first dynamic-acceleration signal A_{YD}.

The comparison stage 16 comprises a first upper-threshold comparator 21, a second upper-threshold comparator 22, a first lower-threshold comparator 23, a second lower-threshold comparator 24, and an output logic circuit 27, having an AND gate 29 and a three-input OR gate 30.

In detail, the first upper-threshold comparator 21 and the first lower-threshold comparator 23 have respective inputs connected to the output 14a of the first transduction stage 14 and therefore receive the absolute value |A_{XD}| of the first dynamic-acceleration signal A_{XD}. The second upper-threshold comparator 22 and the second lower-threshold comparator 24 have, instead, respective inputs connected to the output 15a of the second transduction stage 15, so as to receive the absolute value |A_{YD}| of the second dynamic-acceleration signal A_{YD}. Furthermore, the first and the second upper-threshold comparators 21, 22 have outputs connected to a first input 30a and to a second input 30b, respectively, of the OR gate 30, while the first and the second lower-threshold comparators 23, 24 have outputs connected to a first input 29a and to a second input 29b, respectively, of the AND gate 29; the output of the AND gate 29 is connected to a third input 30c of the OR gate 30, and the output of the OR gate 30 forms an output 10a of the inertial device 10 and supplies a recognition signal R.

The first upper-threshold comparator 21 and the first lower-threshold comparator 23 supply at output a first threshold-exceeding signal SX_{H} and a second threshold-exceeding signal SX_{L}, respectively. In particular, the first and the second threshold-exceeding signals SX_{H}, SX_{L} are set at a first logic value (high), when the absolute value |A_{XD}| of the first dynamic-acceleration signal A_{XD} is greater than a first upper threshold X_{H} and, respectively, than a first lower threshold X_{L}, that is lower than the first upper threshold X_{H} (see also FIG. 4), and are set at a second logic value (low) otherwise.

The second upper-threshold comparator 22 and the second lower-threshold comparator 24 supply at output, respectively, a third threshold-exceeding signal SY_{H} and a fourth threshold-exceeding signal SY_{L}. The third and fourth threshold-exceeding signals SY_{H}, SY_{L} are set at the first logic value (high), when the absolute value |A_{YD}| of the second dynamic-acceleration signal A_{YD} is higher than a second upper threshold Y_{H}, and, respectively, a second lower threshold Y_{L}, lower than the second upper threshold Y_{H}, and are set at the second logic value (low) otherwise.

Hence, the output logic circuit 27 implements the following combinatorial function:

R=SX_{H} OR SY_{H} OR (SX_{L} AND SY_{L}).

In practice, the recognition signal is set at the first logic value (high) when at least one of the following conditions is verified:

the absolute value |A_{XD}| of the first dynamic-acceleration signal A_{XD} is greater than the first upper threshold X_{H};

the absolute value |A_{YD}| of the second dynamic-acceleration signal A_{YD} is greater than the second upper threshold Y_{H}; and

the absolute value |A_{XD}| of the first dynamic-acceleration signal A_{XD} and the absolute value |A_{YD}| of the second dynamic-acceleration signal A_{YD} are greater than the first lower threshold X_{L} and, respectively, the second lower threshold Y_{L}.

Otherwise, the recognition signal R is set at the second logic value (low).

Consequently, the detection of an acceleration due to a force acting on the inertial device 10 is associated to the first logic value of the recognition signal R.

In the preferred embodiment described (FIG. 4), the first and second thresholds X_{H}, Y_{H} are equal to one another and the first and the second lower threshold X_{L}, Y_{L} are equal to one another; moreover, the ratio between the upper threshold X_{H} and the first lower threshold X_{L}, and the ratio between the second upper threshold X_{H} and the second lower threshold Y_{L} are substantially equal to 1/\sqrt{2}. The first and the second upper thresholds X_{H}, Y_{H} represent the minimum absolute value that an acceleration must have to be detected when it is parallel to the first preferential detection axis X or to the second preferential detection axis Y.

In practice, the dynamic components of acceleration along each of the preferential detection axes X, Y are compared with a respective upper threshold (X_{H}, Y_{H}) and a respective lower threshold (X_{L}, Y_{L}). If in at least one of the two cases the upper threshold is exceeded, the inertial device 10 detects in any case an acceleration and hence the action of a force; otherwise, acceleration is detected if the components which are parallel to the preferential detection axes X, Y are simultaneously greater than the respective lower thresholds.

In the preferred embodiment described, in particular, an acceleration A (FIG. 4) which forms an angle of 45° with the preferential detection axes X, Y and has an absolute value higher than the first and the second upper thresholds X_{H}, Y_{H} is always detected, whereas an acceleration having an absolute value smaller than the first and the second lower thresholds X_{L}, Y_{L} is never detected. Furthermore, the maximum possible error (i.e., whereby the maximum absolute value such that the detection may fail) is verified in the presence of the accelerations A′, A″ of FIG. 4. In the case of the acceleration A′, if |A_{ERR}| designates the maximum error possible, we have:

|A_{ERR}|=\sqrt{X_{L}²+Y_{H}²}=\sqrt{X_{L}²+Y_{H}²}={square root over ((X_{H}/2)})²+X_{H}²

|A_{ERR}|=X_{H}\sqrt{3/2}=1.22·X_{H}

As is clear from the above description, the inertial device advantageously enables the efficiency of detection of the accelerations to be improved and the maximum error that might be committed to be reduced considerably. Thanks to the use of two thresholds for each preferential detection axis, it is in fact possible to detect accelerations with directions significantly different from the preferential detection axes, even when none of the upper thresholds is reached.

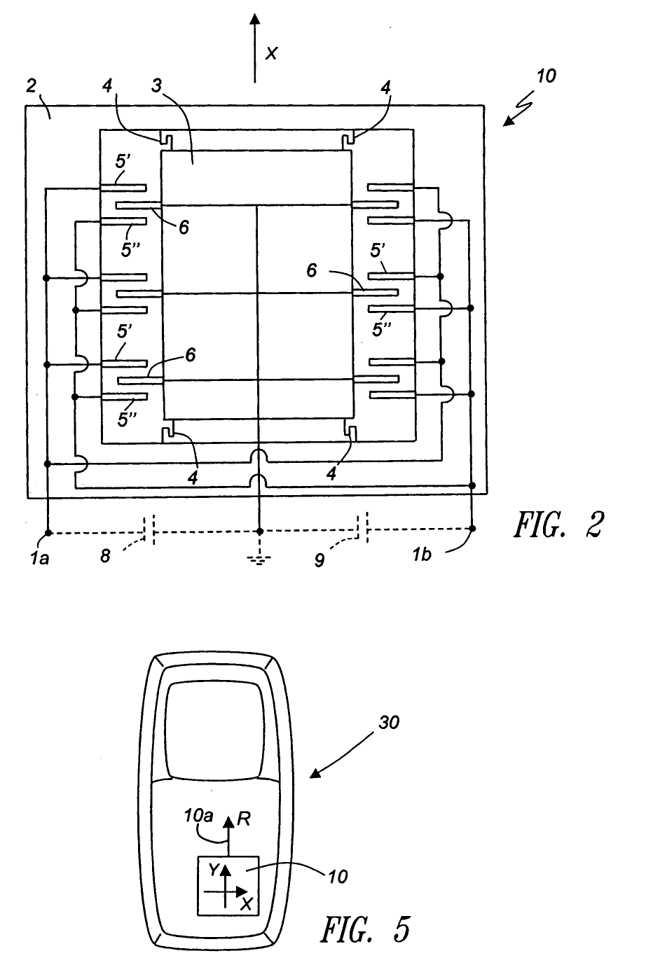

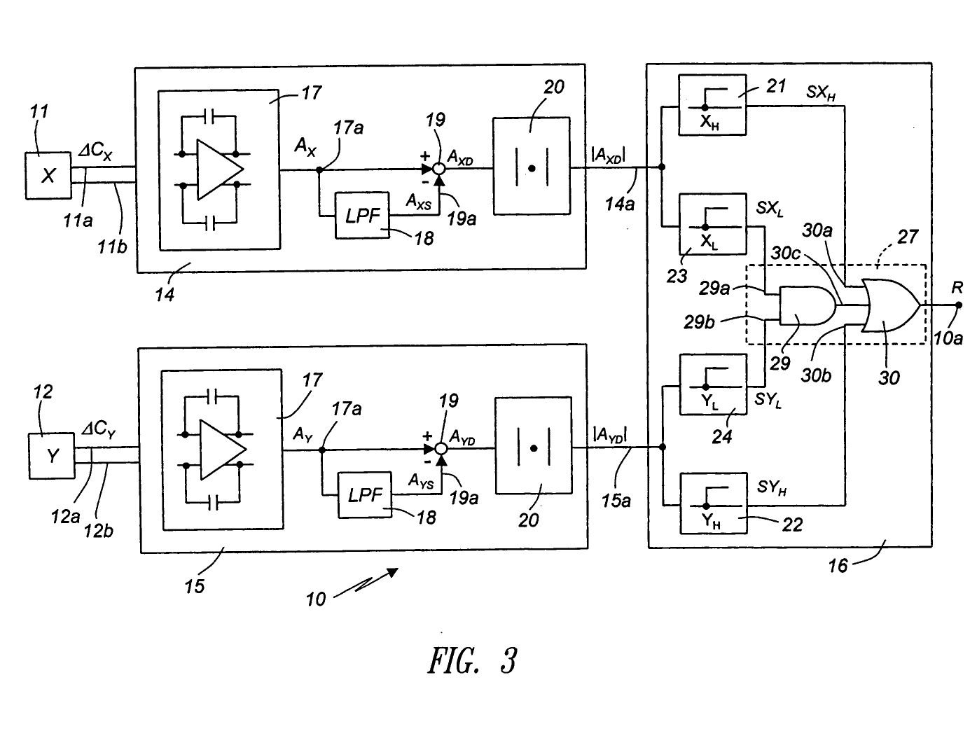

The inertial device described herein is moreover particularly suitable for being used as a device for reactivation from stand-by in portable electronic apparatus, such as cell phones or palm-top computers. To minimize consumption and thus increase autonomy, these types of apparatus in fact go into stand-by after a period of inactivity. With reference to FIG. 5, a portable electronic apparatus 30 (here a cell phone) incorporating the inertial device 10 according to the invention can be automatically brought back into the active state as soon as a movement is detected, i.e., when the recognition signal R is brought to the first logic value (for example, when the apparatus is picked up by a user). Advantageously, the dynamic-acceleration signals A_{XD}, A_{YD} provided by the transduction stages 14, 15 of the inertial device 10 are correlated only to the accelerations due to variable forces and, in practice, are different from zero only when the apparatus 30 is moved, in particular when it is picked up to be used. Note that, since the apparatus 30 may be variously oriented both during use and when it is not in use, not necessarily the components of the force of gravity along the preferential detection axes X, Y are always constant and they can be non-zero even when the apparatus 30 is not moved. However, as long as the apparatus 30 remains at rest, the force of gravity provides constant contributions to the acceleration signals A_{X}, A_{Y}, but zero contribution to the dynamic acceleration signals A_{XD}, A_{YD}. When, instead, the apparatus 30 is moved, also the force of gravity can advantageously provide a contribution to the dynamic-acceleration signals A_{XD}, A_{YD}, since the orientation of the preferential detection axes X, Y can vary with respect to the vertical direction (i.e., with respect to the direction of the force of gravity). Consequently, the movement due to the intervention of the user is more readily detected.

Furthermore, the use of MEMS-type inertial sensors, which are extremely sensitive, have small overall dimensions, can be built at relatively low costs, and above all have virtually negligible levels of consumption, is particularly advantageous.

Finally, it is clear that modifications and variations can be made to the device described herein, without thereby departing from the scope of the present invention.

In particular, the activation device 10 could have a third preferential detection axis, not parallel to and preferably orthogonal to the first two axes, and could comprise an inertial sensor and a transduction stage to detect the accelerations parallel to this third axis. Furthermore, a single inertial sensor with more than one degree of freedom can be used, instead of a plurality of inertial sensors with a single degree of freedom.

It is moreover possible to envisage a single transduction stage, connectable in sequence to the outputs of the inertial sensors (or of the inertial sensor) by means of a multiplexer; in this case, the signals provided in sequence by the transduction stage, corresponding to different preferential detection axes, can be temporarily stored in a register and then provided at a pre-determined instant to the comparison stage 16.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A multidirectional inertial device having a plurality of preferential detection axes, comprising:
inertial sensor means, which are sensitive to accelerations parallel to said preferential detection axes;
transduction means, coupled to said inertial sensor means and supplying a plurality of acceleration signals, each of which is correlated to an acceleration parallel to a respective one of said preferential detection axes;
first comparison means, connected to said transduction means and supplying a pre-determined logic value when at least one of said acceleration signals is greater than a respective upper threshold; and
second comparison means, connected to said transduction means and to said first comparison means for supplying said pre-determined logic value when each of said acceleration signals is greater than a respective lower threshold, which is smaller than the respective upper threshold.

2. The device according to claim 1 wherein said first comparison means comprise, for each said preferential detection axis, a respective first comparator, which receives the respective one of said upper thresholds and receives the respective one of said acceleration signals, and at least one first logic gate, connected to each first comparator.

3. The device according to claim 2 wherein said second comparison means comprise, for each of said preferential detection axes, a respective second comparator, which the respective one of said lower thresholds and receives the respective one of said acceleration signals, and at least one second logic gate, connected to each second comparator.

4. The device according to claim 1 wherein said upper thresholds are equal to one another, and said lower thresholds are equal to one another.

5. The device according to claim 1 wherein the ratio between the upper threshold and the lower threshold corresponding to a same one of said preferential reference axes is substantially equal to 1/\sqrt{2}.

6. The device according to claim 1 wherein said inertial sensor means comprise at least one micro-electro-mechanical sensor with capacitive unbalancing.

7. The device according to claim 6 wherein said inertial sensor means comprise a micro-electro-mechanical capacitive-unbalance sensor for each of said preferential detection axes.

8. The device according to claim 6 wherein said transduction means comprise:
at least one current-to-voltage converter, connectable to said at least one micro-electro-mechanical sensor;
a subtractor node, having a non-inverting input connected to an output of said current-to-voltage converter;
an inverting input;
a filter, connected between said output of said current-to-voltage converter and said inverting input of said subtractor node; and
a rectifier, which is connected to an output of said subtractor node and supplies at least one of said respective acceleration signals.

9. A portable electronic apparatus, comprising:
a device for reactivation from stand-by, said device including a multidirectional inertial device that includes:
inertial sensor means, which are sensitive to accelerations parallel to each of a plurality of preferential detection axes;
transduction means, coupled to said inertial sensor means and supplying a plurality of acceleration signals, each of which is correlated to an acceleration parallel to a respective one of said preferential detection axes;
first comparison means, connected to said transduction means and supplying a pre-determined logic value when at least one of said acceleration signals is greater than a respective upper threshold; and
second comparison means, connected to said transduction means and to said first comparison means for supplying said pre-determined logic value when each of said acceleration signals is greater than a respective lower threshold, which is smaller than the respective upper threshold.

10. A method for detecting the state of motion of a device, comprising:
generating a plurality of acceleration signals, each of which is correlated to an acceleration parallel to a respective preferential detection axis;
supplying a pre-determined logic value when at least one of said acceleration signals is greater than a respective upper threshold; and
supplying a pre-set logic value when each of said acceleration signals is greater than a respective lower threshold, which is smaller than the respective upper threshold.

11. The method according to claim 10 wherein said higher thresholds are equal to one another, and said lower thresholds are equal to one another.

12. The method according to claim 10 wherein the ratio between the upper threshold and the lower threshold corresponding to a same one of said preferential reference axes is substantially equal to 1/\sqrt{2}.

13. A device, comprising:
an acceleration circuit configured to produce a dynamic acceleration signal corresponding to a level of acceleration in each of a plurality of detection axes;
a comparator circuit for each of the detection axes, configured to compare the respective dynamic acceleration signal with respective higher and lower threshold signals; and
a logic circuit configured to produce a selected logic value at an output if the dynamic acceleration signal of any of the plurality of detection axes exceeds its respective higher threshold, or if the dynamic acceleration signals of any two of the plurality of detection axes exceeds their respective lower thresholds.

14. The device of claim 13 wherein the acceleration circuit comprises:
a sensor configured to sense acceleration in each of the detection axes; and
a transduction circuit for each of the detection axes, each transduction circuit configured to receive from the sensor an acceleration value corresponding to a level of acceleration in the respective one of the detection axes and to produce the respective dynamic acceleration signal.

15. The device of claim 14 wherein each of the transduction circuits is configured to subtract, from the respective acceleration value, a respective static acceleration value, thereby producing the respective dynamic acceleration signal.

16. The device of claim 14 wherein the sensor comprises a micro-electro-mechanical capacitive-unbalance sensor for each of the plurality of detection axes.

17. The device of claim 13 wherein the acceleration circuit comprises:
a sensor configured to sense acceleration in each of the detection axes; and
a transduction circuit configured to receive from the sensor an acceleration value corresponding to a level of acceleration in each of the plurality of detection axes, sequentially, and to produce, for each detection axis, its respective dynamic acceleration signal.

18. The device of claim 13 wherein the number of detection axes is two.

19. The device of claim 13, further comprising a cell phone.

20. The device of claim 13, further comprising a portable computer.

21. A method, comprising:
sensing acceleration of a device in each of a plurality of axes;
comparing respective levels of the acceleration in the axes with a high threshold;
comparing the respective levels of the acceleration in the axes with a low threshold;
producing a selected logic value if the level of the acceleration with respect to any one of the plurality of axes exceeds the high threshold; and
producing the selected logic value if the level of the acceleration with respect to any two of the plurality of axes exceeds the low threshold.

22. The method of claim 21 wherein each of the plurality of axes lies at right angles to each other.
